(19) United States
(12) Patent Application Publication
(10) Pub. No.: US 2023/0186203 A1
(43) Pub. Date: Jun. 15, 2023

(54) INTELLIGENT DEPENDENCY MANAGEMENT SYSTEM

(71) Applicant: Accenture Global Solutions Limited, Dublin (IE)

(72) Inventors: Aditi KULKARNI, Bangalore (IN); Jayashri SRIDEVI, Chennai (IN); Koushik M. VIJAYARAGHAVAN, Chennai (IN); Rajesh NAGARAJAN, Chennai (IN); Pritha LATHA, Bangalore (IN); Chetan Rajendra DAHALE, Pune (IN); Parul JAGTAP, West Delhi (IN)

(21) Appl. No.: 17/549,247

(22) Filed: Dec. 13, 2021

(51) Int. Cl. G06Q 10/06; G06F 40/40

(52) U.S. Cl. CPC G06Q 10/06312; G06Q 10/06313; G06Q 10/0633; G06F 40/40

(57) ABSTRACT

In some implementations, a device may receive project management data including text descriptions related to one or more requirements associated with a project. The device may identify a set of work items associated with the project and a set of existing dependencies among the set of work items associated with the project. The device may generate, based on the text descriptions related to the one or more requirements associated with the project, a set of recommended dependencies among the set of work items associated with the project using an artificial intelligence model. The device may generate a user interface to visually indicate information related to the set of existing dependencies and the set of recommended dependencies among the set of work items associated with the project and to provide one or more elements to manage the set of existing dependencies and/or the set of recommended dependencies.

### BACKGROUND

Project management generally refers to techniques to apply processes, methods, skills, knowledge, and experience to lead one or more teams to achieve specific project objectives or goals within given constraints. For example, the main constraints in project management typically relate to scope, time, and budget, and additional challenges may include optimizing how inputs are allocated and applied to satisfy predefined objectives. Project management may differ from routine operations in that project management has final deliverables (e.g., a new product launch, an update to a version or feature of an existing product, offering a new service, and/or developing internal work product, among other examples) that are constrained to a finite timescale and budget. Accordingly, because a project is a temporary endeavor designed to produce a unique product, service, or result with a defined scope (usually time-constrained, and often constrained by funding or staffing), project management requires significant planning and coordination, including estimations about a complexity of the project, a quantity and type of resources needed to carry out the project, and/or current and forecasted availability of resources to complete the project. To make these estimations accurately and effectively, organizations typically engage project professionals to plan the project and coordinate resources to carry out the project. For example, project professionals may use various project management tools to plan or organize tasks, track progress, and manage time to deliver a successful project.

### SUMMARY

Some implementations described herein relate to a method. The method may include receiving, by a device, project management data that includes text descriptions related to one or more requirements associated with a project. The method may include identifying, by the device, a set of work items associated with the project and a set of existing dependencies among the set of work items associated with the project, where the set of work items and the set of existing dependencies associated with the set of work items are identified based on the project management data, and where each existing dependency of the set of existing dependencies defines a respective relationship between a first work item and a second work item. The method may include generating, by the device and based on the text descriptions related to the one or more requirements associated with the project, a set of recommended dependencies among the set of work items associated with the project using an artificial intelligence model, where the artificial intelligence model is trained to predict the set of recommended dependencies using historical data related to closed work items. The method may include generating, by the device, a user interface to visually indicate information related to the set of existing dependencies and the set of recommended dependencies among the set of work items associated with the project, where the user interface includes one or more elements to manage one or more of the set of existing dependencies or the set of recommended dependencies.

Some implementations described herein relate to a device. The device may include one or more memories and one or more processors coupled to the one or more memories. The device may be configured to receive project management data that includes text descriptions related to one or more requirements associated with a project. The device may be configured to identify a set of work items associated with the project and a set of existing dependencies among the set of work items associated with the project. The device may be configured to generate, based on the text descriptions related to the one or more requirements associated with the project, a set of recommended dependencies among the set of work items associated with the project using an artificial intelligence model. The device may be configured to generate a user interface to visually indicate information related to the set of existing dependencies and the set of recommended dependencies among the set of work items associated with the project. The device may be configured to receive one or more inputs related to interaction with one or more elements included in the user interface. The device may be configured to process the one or more inputs to manage one or more of the set of existing dependencies or the set of recommended dependencies. The device, to process the one or more inputs, may be configured to update the project management data to include a recommended dependency, of the set of recommended dependencies, based on the one or more inputs accepting the recommended dependency. The device, to process the one or more inputs, may be configured to generate feedback to update the artificial intelligence model based on the one or more inputs rejecting a recommended dependency, of the set of recommended dependencies.

Some implementations described herein relate to a non-transitory computer-readable medium that stores a set of instructions for a device. The set of instructions, when executed by one or more processors of the device, may cause the device to receive project management data that includes text descriptions related to one or more requirements associated with a project. The set of instructions, when executed by one or more processors of the device, may cause the device to identify a set of work items associated with the project and a set of existing dependencies among the set of work items associated with the project. The set of instructions, when executed by one or more processors of the device, may cause the device to generate, based on the text descriptions related to the one or more requirements associated with the project, a set of recommended dependencies among the set of work items associated with the project using an artificial intelligence model. The set of instructions, when executed by one or more processors of the device, may cause the device to perform an impact analysis to identify one or more dependencies, of the set of existing dependencies or the set of recommended dependencies, that have a potential to delay the project or cause one or more deadlines associated with the project to be missed. The set of instructions, when executed by one or more processors of the device, may cause the device to determine, based on the set of existing dependencies and the set of recommended dependencies, a critical path that includes a sequence of work items to be completed before a deadline associated with the project. The set of instructions, when executed by one or more processors of the device, may cause the device to generate a user interface to visually indicate information related to one or more of the set of existing dependencies, the set of recommended dependencies among the set of work items associated with the project, a current status associated with the one or more dependencies that have the potential to delay the project or cause the one or more deadlines associated with the project to be missed, or the critical path.

### BRIEF DESCRIPTION OF THE DRAWINGS

FIGS. 1A-1D are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process relating to intelligent dependency management.

### DETAILED DESCRIPTION

The following detailed description of example implementations refers to the accompanying drawings. The same reference numbers in different drawings may identify the same or similar elements.

Project management is typically a complex task with many facets, which requires distinct technical skills and management strategies. For example, as described above, project management requires significant planning and coordination, including estimations about a complexity of the project, a quantity and type of resources needed to carry out the project, and/or current and forecasted availability of resources to complete the project, among other examples. Another challenging issue that often arises in project management relates to project dependencies, which are pervasive in technical and non-technical industries. In a project management context, a dependency is a logical, constraint-based, or preferential relationship between two work items (which may be referred to herein interchangeably as work items, tasks, and/or activities, among other examples) such that starting and/or finishing a first task is dependent on a second task starting and/or finishing. For example, a given project will typically involve various work items that need to be started, completed, or otherwise performed in a particular order (possibly including some work items that can be performed in parallel), whereby setting out the dependencies in a project is usually crucial to the project succeeding. For example, effectively managing dependencies within a project generally helps both the project manager(s) and project team(s) work and manage tasks in the best possible order, which helps to ensure that a project will be completed on time (or early), within budget (or under budget), and/or in a manner that satisfies objectives.

Accordingly, as part of an end-to-end flow in managing project requirements, project professionals may spend significant time identifying dependencies among work items during a planning phase. Defining the dependencies among work items may be needed to lay out one or more sequences of work items within the project plan, calculate a critical path for the project (e.g., identify the sequence of work items that must be completed before the project deadline), identify necessary resources to complete the work items, identify potential scheduling issues, monitor and manage work items during execution of the project plan, and/or identify and take action on any opportunities to optimize the project plan (e.g., accelerating a schedule and/or reducing a cost). Accordingly, project professionals need to plan and track dependencies accurately and efficiently to avoid situations that may prevent associated work items from being executed, which can lead to adverse outcomes such as preventing the project from progressing, missed deadlines, slippage in a release or deliverable timeline, and/or disorder on a project team. The risks associated with inaccurate and/or inefficient dependency management may be worsened in cases where key dependencies are overlooked, mischaracterized, or otherwise inadequately accounted for in a project plan. These risks may become increasingly probable when human personnel are tasked with planning and tracking dependencies in a project, because comprehensively managing all dependencies is a difficult and cumbersome process, especially when a project involves a large number of functional entities. In many cases where projects are delayed, deadlines are missed, and/or quality is compromised, the delays, missed deadlines, and/or poor quality may be attributed to critical defects that arise in the project plan due to a failure to accurately and comprehensively identify dependencies in the initial planning stage.

However, existing tools to manage project dependencies fall short in providing a capability to identify dependencies among work items associated with a project. For example, one tool that is often used to visualize project dependencies is a Gantt chart, which can help to track the time that a project is taking to complete, allocate resources to the project, and/or order the tasks or work items within the project. Other tools include logic networks that show the sequence of work items, tasks, or activities that logically come before or after a different work item, task, or activity, and a Program Evaluation and Review Technique (PERT) chart that can lay out the minimum time needed to complete a project and show a hierarchical breakdown of project requirements. Accordingly, existing tools to manage dependencies are generally limited to visualizing dependencies that have already been identified and defined by project professionals, and therefore fail to adequately mitigate the risks that may arise if key dependencies are overlooked, mischaracterized, or otherwise unaccounted for in a project plan.

Some implementations described herein relate to an intelligent dependency management system that may identify dependencies associated with a project using an artificial intelligence model and thereby reduce overall planning efforts associated with identifying, tracking, or otherwise managing dependencies among work items that are scheduled to carry out a project plan. For example, as described in further detail herein, the intelligent dependency management system may predict dependencies among work items using a natural language processing (NLP) model trained to identify dependencies among work items based on similarities in text descriptions related to various functional entities associated with a project. For example, in some implementations, the text descriptions may relate to requirements, user stories, epics, features, tasks, risks, issues, actions, decisions, change requests, feedback, milestones, deliverables, and/or any other suitable functional entity associated with a project. Accordingly, the intelligent dependency management system described herein may be used to support any suitable project management scenario, such as managing a software development lifecycle using an agile, waterfall, or iterative methodology, coordinating factory operations, and/or planning a construction project, among many other examples. In this way, as described herein, the intelligent dependency management system may be used to automate the prediction and identification of dependencies within a project, recommend a dependency type and provide a confidence score for the predicted dependencies, provide a user with flexibility to accept or override (e.g., reject or modify) the predicted dependencies, and/or enable project analytics such as critical path analysis, impact analysis, and/or root cause analysis, among other examples.

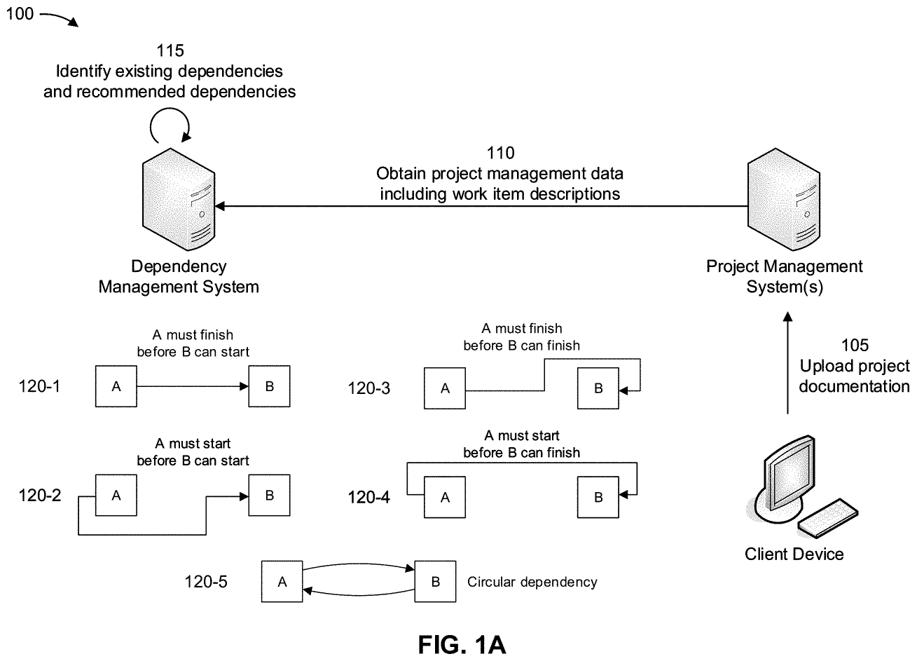

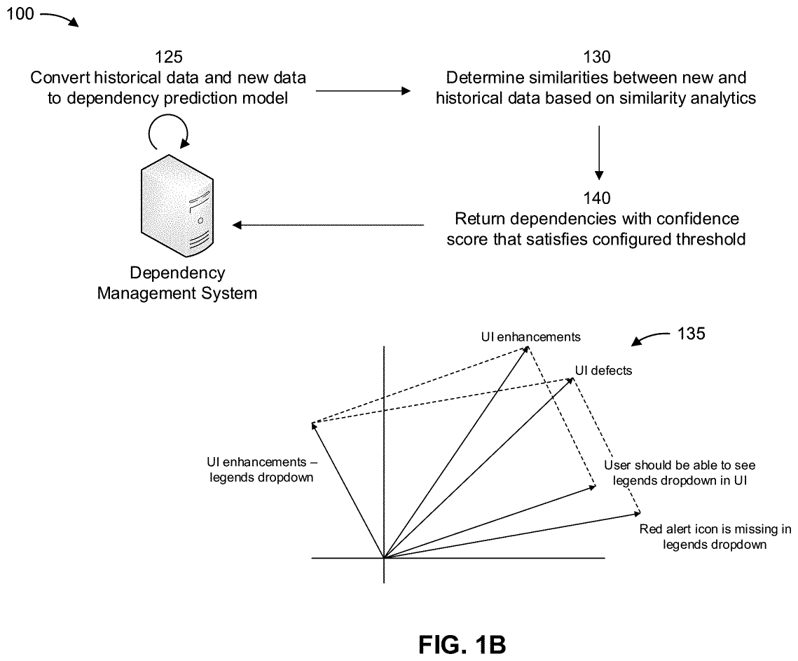

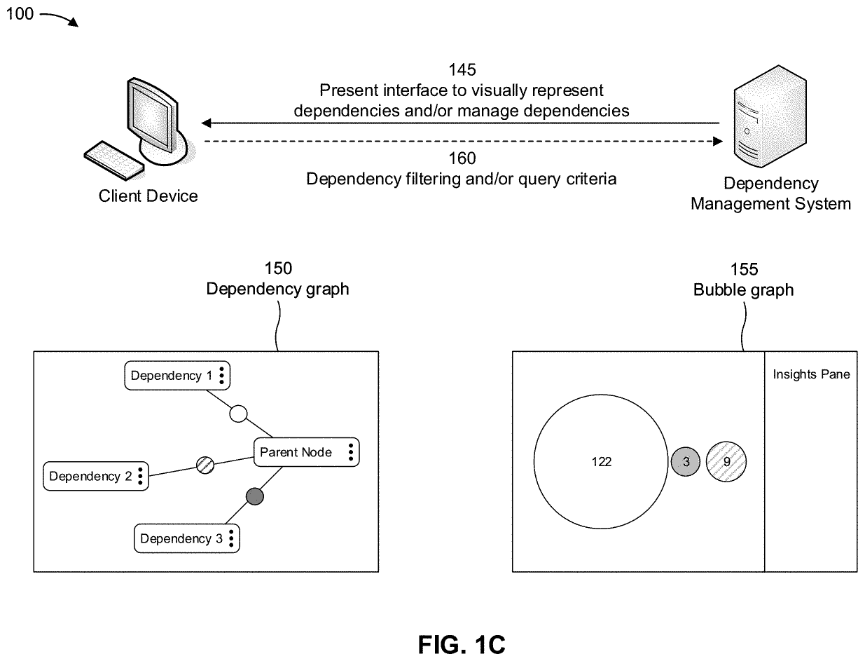

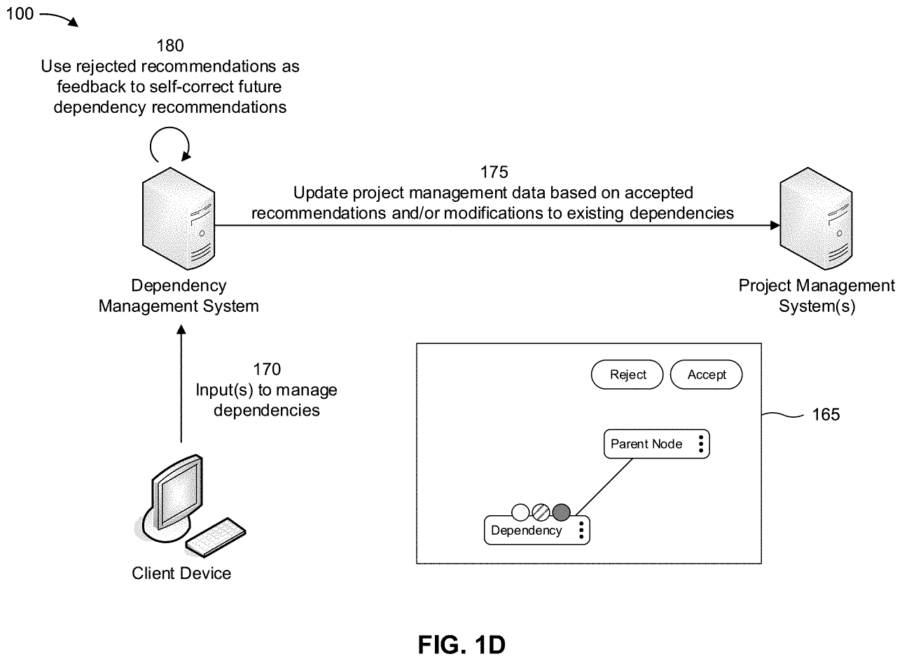

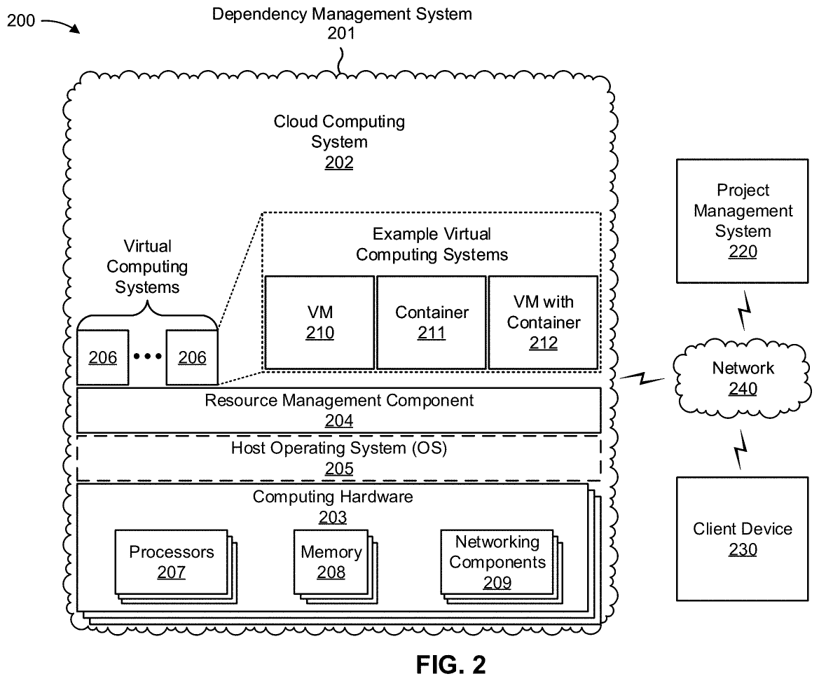

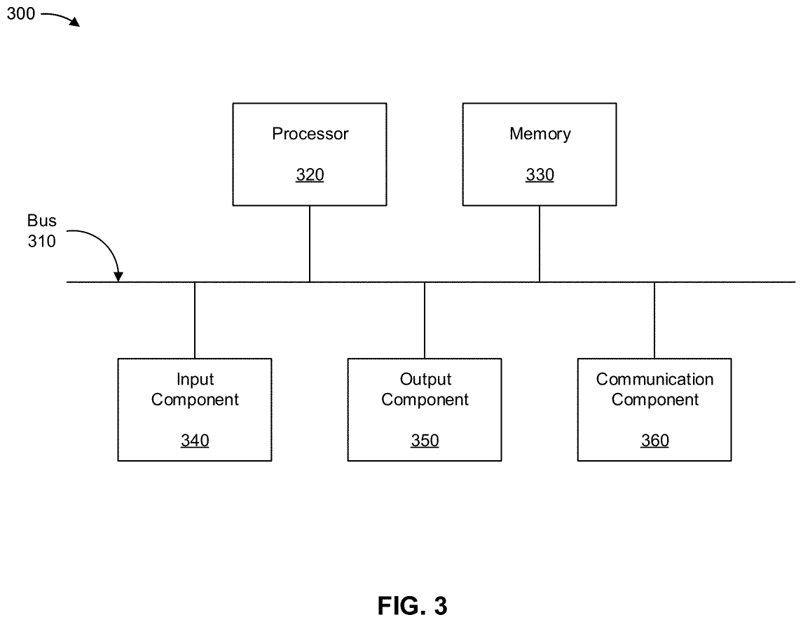

FIGS. 1A-1D are diagrams of an example implementation 100 associated with intelligent dependency management. As shown in FIGS. 1A-1D, example implementation 100 includes a dependency management system, one or more project management systems, and a client device. The dependency management system, the project management system(s), and the client device are described in more detail below in connection with FIG. 2 and FIG. 3.

As shown in FIG. 1A, and by reference number 105, the client device may upload project documentation to the project management system(s). For example, the project documentation may generally include one or more technical documents and/or one or more functional documents that describe various requirements or functional entities associated with a project. In some implementations, the project documentation may be created and uploaded to the project management system(s) during any suitable phase in a project, such as an initial planning phase and/or during an execution phase. The project documentation may generally include text descriptions that relate to all relevant project details, including objectives, constraints, and/or work items to be performed. The project documentation may therefore include various textual data sources that describe the project plan and ongoing project efforts, which may be referenced to ensure that project requirements are fulfilled and provide traceability with regard to which work items have been performed, who performed the work items, when the work items were performed, which work items are scheduled to be performed in the future, and/or when the future work items are scheduled to be performed, among other examples. Accordingly, as described herein, the project documentation that is uploaded to the project management system(s) can be used to obtain relevant data sources (e.g., textual descriptions) to identify dependencies among work items for any suitable phase within the scope of a project.

As further shown in FIG. 1A, and by reference number 110, the dependency management system may obtain project management data that includes textual descriptions related to one or more requirements associated with a project from the project management system(s). For example, as described herein, the project management system(s) may include one or more devices executing a Jira software product used for issue tracking and agile project management, an application lifecycle management (ALM) tool used for software development lifecycle management, an Azure DevOps Server or Team Foundation Server (TFS) product (e.g., enabling project management for agile, waterfall, and/or iterative software development), and/or any other suitable project management software or project management utility. Accordingly, in some implementations, the project management data obtained from the project management system(s) may include text descriptions that relate to one or more requirements, user stories, epics, features, tasks, risks, issues, actions, decisions, change requests, feedback, milestones, deliverables, and/or any other functional entities associated with a project. For example, the text description associated with a functional entity may include a title and a natural language description that includes one or more text chunks (e.g., sentences, paragraphs, and/or bullet points, among other examples) that are used to document the respective functional entity.

As further shown in FIG. 1A, and by reference number 115, the dependency management system may identify a set of existing dependencies and a set of recommended dependencies associated with a project based on the project management data. For example, as described herein, dependencies among work items associated with a project may generally refer to relationships between preceding work items and succeeding work items, where any particular dependency may include multiple preceding work items and/or multiple succeeding work items. For example, in FIG. 1A, reference number 120-1 depicts a finish-to-start dependency, where a first work item (shown as work item A) must finish before a second work item (shown as work item B) is allowed to start. In another example, reference number 120-2 depicts a start-to-start dependency, where the second work item cannot start until the first work item has started. In other examples, reference number 120-3 depicts a finish-to-finish dependency, where the second work item cannot finish until the first work item has finished, and reference number 120-4 depicts a start-to-finish dependency, where the second work item cannot finish until the first work item has started. Furthermore, reference number 120-5 depicts a circular dependency, where the second work item depends on the first work item the first work item depends on the second work item (e.g., where starting or finishing the second work item depends on whether the first work item has started or finished and vice versa). Accordingly, each dependency in the set of existing dependencies and the set of recommended dependencies may include a dependency type, such as a “blocked by” dependency type, where a first work item completely blocks a second work item such that no work can take place on the second work item until the blocking work item is finished. Alternatively, a dependency may have a “depends on” type, where a first work item should be finished before a second work item is started. For example, in the case of a depends on dependency type, extending the deadline for a first work item may cause the starting date/time and/or deadline for a second work item to be automatically extended to accommodate the changed schedule. Alternatively, a dependency that is identified by the dependency management system may have a “linked by” type, which may refer to a dependency in which two work items can proceed in parallel (e.g., independently) but must be finished together (e.g., a first work item must be deployed with a second work item so that both work items function correctly). Furthermore, one or more dependencies may have a “circular” type to refer to dependencies in which two work items each depend on the other work item.

In some implementations, as described herein, the dependency management system may identify a set of existing dependencies, which may include one or more blocked by dependencies, one or more depends on dependencies, and/or one or more linked by dependencies, based on the project management data obtained from the project management system(s). For example, in some implementations, the set of existing dependencies may be explicitly defined in the project management data (e.g., based on inputs from one or more project professionals or project documentation uploaded to the project management system(s)). Furthermore, in some implementations, each dependency in the set of existing dependencies may be classified as an internal dependency between two work items that are within the scope of the project (e.g., two work items that are performed by one or more teams within an organization carrying out the project) or an external dependency between a first work item that is within the scope of the project and a second work item that is outside the scope of the project (e.g., a work item performed by an entity outside the organization, such as a vendor or supplier). Accordingly, the dependency management system may classify each dependency as an internal dependency between two work items within the project, in which case the project team has control over completing the dependency and completion is not dependent on any outside sources, or as an external dependency in which an input or trigger from an external source is required before a work item can proceed. The internal versus external distinction may be used to establish relationships between work items that are within the scope of the project and work items that are outside the scope of the project (e.g., work items that the project team does not control but must nonetheless be considered in the project schedule).

In some implementations, the dependency management system described herein may generally identify a set of work items associated with a project and a set of existing dependencies among the set of work items associated with the project based on the project management data obtained from the project management system(s). For example, the set of existing dependencies may be user-defined, and each dependency in the set of existing dependencies may define a respective relationship between a first work item and a second work item. Furthermore, in addition to the user-defined existing dependencies, the dependency management system may use an artificial intelligence model to identify one or more recommended dependencies based on similarity analytics pertaining to the text descriptions (e.g., titles and natural language narratives) associated with the work items. For example, as described in further detail below with reference to FIG. 1B, the artificial intelligence model may include an NLP-based model or an artificial intelligence engine that is trained using historical data related to closed work items (e.g., work items that have been completed) to predict recommended dependencies and corresponding dependency attributes (e.g., whether the recommended dependencies have a blocked by, depends on, or linked by type, whether the recommended dependencies are internal or external, and/or whether the recommended dependencies relate to associations between or among two attributes, platforms, integration layers, change control board approvals, indirect relationships, deliverables, and/or other suitable entities). In some implementations, the dependency management system may generate one or more user interfaces to visually indicate information related to the existing and recommended dependencies that are identified by the dependency management system, which may help project professionals to plan work items accordingly and ensure that the project plan progresses toward a target in a smooth and predictable manner (e.g., by identifying and monitoring dependencies to help avoid any interruptions or delays in the project schedule).

Accordingly, by identifying the existing dependencies based on the project management data and identifying the recommended dependencies using the artificial intelligence model, the dependency management system may enable project professionals to eliminate unnecessary dependencies and/or resolve dependencies in a timely manner to help reduce the risk that a failure will cascade through the chain of dependencies. Furthermore, as described herein, identifying the existing dependencies and the recommended dependencies may be used to determine a critical path associated with the project, which may generally include a sequence of work items that must be completed before the project deadline. In addition, the dependency management system may be configured to perform an impact analysis to identify a potential impact associated with each dependency and identify a prioritized list of dependencies that have a largest impact (e.g., based on logic rules, deadlines, and/or other suitable criteria). In some implementations, the dependency management system may improve project management in various other ways, such as by providing stakeholder clarity regarding responsibilities and dependencies on others by classifying dependencies as internal or external, providing valuable insight into the impact that each dependency may have within the project plan to proactively manage the dependencies, providing an action plan to monitor dependencies and prevent interruptions by triggering alerts (e.g., to the client device) based on a frequency or notification conditions configured by one or more users, managing dependencies across functional groups to ensure that different teams communicate effectively to plan and complete dependencies, and/or generating notifications to interested and responsible parties to ensure that immediate attention is given to time-sensitive dependencies that may be causing delays or may have the potential to cause delays in the project plan.

As described herein with reference to FIG. 1B, the dependency management system may use an artificial intelligence model that supports natural language processing (NLP) techniques to identify the set of recommended dependencies based on the text descriptions included in the project management data obtained from the project management system(s). For example, NLP is a subfield in linguistics, computer science, and artificial intelligence concerned with the interactions between computers and human language and programming computers to process and analyze large amounts of natural language data based on various criteria. For example, as described herein, the artificial intelligence model used by the dependency management system may be trained with historical data (e.g., titles and/or natural language descriptions) related to closed work items, which may be compared with text descriptions associated with new work items to suggest or predict recommended dependencies based on similarity analytics using a configurable threshold. For example, as described herein, the dependency management system may determine a similarity metric between two text chunks (e.g., sentences, paragraphs, bullet points, and/or other groups of words) and assign a confidence level to the similarity metric such that a recommended dependency may be identified in cases where the confidence level satisfies (e.g., equals or exceeds) the configured threshold. For example, in some implementations, the threshold may have a value within a range, such as zero (0) to one hundred (100), where a higher value for the threshold may result in relatively fewer recommended dependencies that may be more accurate (e.g., few or no false positives, but potentially more false negatives), whereas a lower value for the threshold may result in relatively more recommended dependencies that may be less accurate (e.g., fewer false negatives, but potentially more false positives). In some implementations, the threshold may be configured to have a default value (e.g., eighty (80)), or the user may configure the threshold (e.g., to increase or decrease the number and/or reliability of the recommended dependencies).

In some implementations, as described herein, the dependency management system may be equipped with an artificial intelligence model that can use text similarities to predict similarities between different requirements, user stories, epics, features, tasks, risks, issues, actions, decisions, change requests, feedback, milestones, deliverables, and/or other suitable functional entities, which may be mapped to the set of recommended dependencies. For example, in some implementations, the dependency management system may include an artificial intelligence recommendation engine, which may be scheduled to run at regular (e.g., periodic) intervals or in response to certain triggers (e.g., new or modified project documentation) to identify the recommended dependencies. The artificial intelligence recommendation engine may then process the text descriptions associated with closed and active records to determine a similarity metric between the text descriptions, and the similarly metric may be associated with a confidence level. The artificial intelligence recommendation engine may then store associations between parent work items and associated work items, which may be used to identify the set of recommended dependencies and predict the type of each recommended dependency (e.g., whether the dependency is internal or external, and/or whether the dependency indicates that a first work item is blocked by, dependent on, or linked to a second work item). Furthermore, in some implementations, the dependency management system may identify any circular dependencies, which may generally occur where a first work item has a dependency on a second work item, and the second work item has a dependency on the first work item. Accordingly, the dependency management system may identify recommended dependencies and corresponding dependency types based on the title, natural language narrative, or other suitable text description associated with any relevant functional entity or work item, which may provide project professionals with a comprehensive set of dependencies to enable critical path analysis, impact analysis, and/or root cause analysis based on an end-to-end visualization of all relevant dependencies with significantly reduced manual effort.

For example, as shown in FIG. 1B, and by reference number 125, the dependency management system may be configured to convert historical project management data and new project management data to a format that is compatible with a dependency prediction model that may support NLP techniques for various languages (e.g., English, Portuguese, German, Spanish, Japanese, Chinese, French, and/or other languages). For example, given a set of work items associated with a project, the dependency management system may process the set of work items to identify historical data (e.g., text descriptions) associated with dependencies that may be relevant to the set of work items and to identify new data (e.g., text descriptions) associated with the work items (e.g., new or active user stories). The dependency management system may then convert the historical data and the new data to a format that is compatible with the artificial intelligence model used to predict the recommended dependencies, such as a bag of words model that may identify similarities between text chunks based on term frequencies. For example, given a first text chunk and a second text chunk, the dependency management system may determine one or more similarity metrics, such as a cosine similarity that represents a closeness between the first text chunk and the second text chunk based on a meaning and/or surface of the first text chunk and the second text chunk. For example, the dependency management system may initially clean the text descriptions being compared by removing stop words (e.g., using a natural language toolkit, such as nltk) and removing tags (e.g., hypertext markup language (HTML) tags) and/or non-alphanumeric words (including special characters) using a regular expression utility. The cleaned text descriptions may then be passed to an NLP model (e.g., the spaCy software library for advanced NLP), which may perform functions such as stemming, dependency parsing, lemmatization, part-of-speech tagging, alpha tokenization, and/or other NLP functions to pre-process the text descriptions. The output from the NLP model (e.g., the cleaned and pre-processed text descriptions) may then be used as an input to the bag of words model that may be derived from a machine learning model (e.g., sklearn) that supports machine learning algorithms such as classification, regression, and/or clustering and/or machine learning data structures such as, random forests, and/or gradient boosting, among other examples.

As further shown in FIG. 1B, and by reference number 130, the bag of words model may then extract features from the text descriptions to find word occurrences, and a frequency of each word may be treated as a classifier for determining a similarity metric between the new and historical data. For example, given a first text chunk of “Global$% Warming is Increasing” and a second text chunk of “Temperature is highly _?rising,” a first data cleaning and pre-processing function may convert the complete textual input to lower case (e.g., “global$% warming is increasing” and “temperature is _?highly rising”). In a second step, all non-alphanumeric characters may be removed from the textual input using a regular expression function (e.g., “global warming is increasing” and “temperature is highly rising”), and a next step may use the NLP model to perform additional pre-processing such as lemmatization (e.g., “Global Warming is Increasing” and “Temperature is highly rising”). In some implementations, the bag of words model may identify unique words contained in the text chunks being compared (e.g., global, warming, is, increasing, temperature, highly, rising), and may count the number of occurrences of the unique words in each text chunk (e.g., the first text chunk includes one (1) occurrence for each of global, warming, is, and increasing, and zero (0) occurrences of temperature, highly, and rising, and the second text chunk includes one (1) occurrence for each of temperature, is, highly, and rising, and zero (0) occurrences of global, warming, and increasing). The bag of words model may then determine a cosine similarity between the first text chunk and the second text chunk, where the cosine similarity measures the cosine of an angle between two vectors. For example, the first text chunk may correspond to a first vector, \vec{u}, of [1, 1, 1, 1, 0, 0, 0] and the second text chunk may correspond to a second vector, \vec{v}, of [0, 0, 1, 0, 1, 1, 1]. The cosine of the angle between the two vectors may then be measured as follows:

$$cos θ = \frac{\vec{u} \cdot \vec{v}}{‖ \vec{u} ‖ ‖ \vec{v} ‖}$$

where the first vector has a length of \sqrt{1²+1²+1²+1²+0²+0²+0²} and the second vector has a length of \sqrt{0²+0²+1²+0²+1²+1²+1²}. Accordingly, whereas an NLP text similarity may indicate only a 25% similarity between the sentences “Global warming is Increasing” and “Temperature is highly rising”, a cosine similarity metric may measure how similar two text chunks are regardless of their size. In particular, from a mathematical perspective, the cosine similarity metric may measure the cosine of the angle between two vectors projected in a multi-dimensional space, which may be advantageous because two similar text chunks that are far apart in Euclidean distance (e.g., due to the size of the text chunk(s)), the text chunks may still be oriented closer together by the cosine similarity metric (e.g., where a smaller angle generally corresponds to a higher cosine similarity). Accordingly, based on the cosine similarity between two text chunks, the artificial intelligence model may generate a confidence score that indicates a likelihood that the two text chunks are similar and therefore relevant to a dependency analysis. For example, to generate the confidence score, the artificial intelligence model may first calculate a similarity metric between a group of text chunks (e.g., if there are three sentences (S1, S2, S3), S1 may be compared with S2 and S3, S2 may be compared with S1 and S3, and S3 may be compared with S1 and S2). In some implementations, each text chunk may be converted into a vector (e.g., using a Tern frequency inverse document frequency (TFIDF) model), and the artificial intelligence model may then calculate the cosine similarity between two text chunks to determine the similarity metric between the two text chunks. For example, in FIG. 1B, reference number 135 illustrates an example where various text chunks that relate to user interfaces are converted to vectors, and cosines of angles between the various vectors are used to determine similarity metrics.

As further shown in FIG. 1B, and by reference number 140, the similarity metrics may be mapped to confidence scores or confidence levels that represent how similar any two text chunks are in terms of semantic meaning and/or structure, and text chunks with confidence levels or confidence scores that satisfy a threshold may be returned to the dependency management system to identify recommended dependencies. For example, in order to derive the confidence level or confidence score that represents the similarity between two text chunks, the dependency management system may determine a minimum score and a maximum score, and may determine a similarity threshold (e.g., 0.75) such that only text descriptions with a similarity score that satisfies the threshold may be considered similar. For example, given a minimum confidence score of sixty (60) and a maximum confidence score of one hundred (100), a minimum similarity threshold may be determined by taking the square root of the minimum confidence score divided by one hundred and rounding the square root to a desired precision (e.g., min_threshold=round (sqrt(min_confidence_score/100), precision)=round (sqrt (60/100), 2)=0.77). Furthermore, a maximum similarity threshold may be determined by taking the square root of the maximum confidence score divided by one hundred and rounding the square root to a desired precision (e.g., max_threshold=round (sqrt(max_confidence_score/100), precision)=round (sqrt (100/100), 2)=1.00). Accordingly, any two text chunks with a similarity metric between the minimum similarity threshold and the maximum similarity threshold (e.g., between 0.77 and 1.00) may be sufficiently similar to consider in the identification of recommended dependencies.

In some implementations, as described herein, the various techniques described above may be used to identify a recommended dependency among work items associated with a project based on similarity analytics associated with a set of at least two open or active stories and a set of at least two closed stories. For example, given a set of three open or active stories (S1, S2, S3) and three closed stories (C1, C2, C3), where C1 is associated with C2 and C3 (e.g., starting or finishing C1 is dependent on starting or finishing C2 and C3, or vice versa), the dependency management system may determine a cosine similarity metric between each open or active story and each closed story. In a case where the cosine similarity metrics for S1 are 0.80, 0.70, and 0.65 with respect to C1, C2, and C3, the dependency management system may determine that S1 is similar to C1 based on the cosine similarity score of 0.80 satisfying (e.g., exceeding) the 0.75 threshold, and S1 may be determined to not be similar to C2 or C3 based on the cosine similarity scores of 0.70 and 0.65 failing to satisfy the 0.75 threshold. In another example, if the cosine similarity metrics for S2 are 0.40, 0.87, and 0.56 with respect to C1, C2, and C3, the dependency management system may determine that S2 is similar to C2 based on the cosine similarity score of 0.87 satisfying (e.g., exceeding) the 0.75 threshold, and S2 may be determined to not be similar to C1 or C3 based on the cosine similarity scores of 0.40 and 0.56 failing to satisfy the 0.75 threshold. Accordingly, in this example, S1 is similar to C1, and C1 has associations with C2 and C3, whereby the dependency management system may search for other open or active stories that are similar to C2 and/or C3 in order to identify the recommended dependencies for S1. For example, as described above, S2 is similar to C2, whereby the dependency management system may identify a recommended dependency between S1 and S2. Furthermore, the dependency management system may calculate a confidence score for the recommended dependency between S1 and S2 as the product of the cosine similarity score between S1 and C1 and the cosine similarity score between S2 and C2. For example, based on the 0.80 cosine similarity score between S1 and C1 and the 0.87 cosine similarity score between S2 and C2, the dependency management system may identify a recommended dependency between S1 and S2, and a confidence score of the recommended dependency may be 0.80*0.87=0.69.

As shown in FIG. 1C, and by reference number 145, the dependency management system may generate a user interface to visually represent or visually indicate information associated with the existing dependencies identified based on the project management data and/or the recommended dependencies identified using the artificial intelligence techniques described above. For example, in some implementations, the dependency management system may support various graphical visualizations to indicate the existing and/or recommended dependencies and to provide interactive user interface elements to enable a user to manage the dependencies. For example, reference number 150 illustrates an example dependency graph, where existing and/or recommended dependencies associated with a parent node may be visually indicated, and a type associated with each dependency may be visually indicated (e.g., using a circular icon, which may have a different fill pattern, shading, shape, or other characteristic(s) depending on whether the dependency is a blocked by dependency, a depends on dependency, a linked to dependency, an internal dependency, and/or an external dependency, among other examples. In another example, reference number 155 depicts a bubble graph, where the various bubbles represent existing dependencies, recommended dependencies, and circular dependencies, with the bubbles having a size that indicates the relative quantity of dependencies in each category and different fill patterns to differentiate the bubbles that represent the existing, recommended, and circular dependencies. Additionally, or alternatively, in some implementations, the graphical visualizations may be varied to represent other details, such as a story point size and/or business value, or other graphical visualizations such as a pie chart may be used to show the count(s) of existing, recommended, and/or circular dependencies and/or a line graph to depict the confidence level for recommended dependencies (e.g., to provide the user with a quick and easily deciphered summary of the different dependencies to enable decision-making relevant to project planning and/or real-time status checks).

In some implementations, the user interface presented to the client device may further enable various analytic use cases, such as regular review of a project schedule to ensure that dependencies are being completed as expected to avoid deadline slippage. In some implementations, the dependency management system may be configured to perform a critical path analysis to identify one or more work items that must be completed to satisfy project objectives, and the user interface presented to the client device may visually indicate a hierarchy among work items and/or information related to timelines to ensure that work items in the critical path are not delayed. Additionally, or alternatively, in cases where one or more work items in the critical path are delayed, the dependency management system may perform a root cause analysis based on the existing and/or recommended dependencies to trace a branch that includes work items causing the scheduling delay and/or visually highlight which work item(s) caused the delay. In this way, the information presented via the user interface may aid the user in immediately mitigating the issue causing the delay and initiating appropriate action to put the project back on track. Furthermore, the existing and/or recommended dependencies may be used to visualize the critical path and indicate overall dependencies that must be resolved in order to provide all relevant deliverables according to schedule.

In some implementations, the dependency management system may generate one or more notifications to be provided to a user of the client device in cases where any work items in the critical path are delayed, which may reduce an overall impact that the delayed work items have on an overall release or sprint execution and/or recommend other work items in the critical path to complete early to compensate for the delay. Accordingly, by providing various ways to view and/or analyze the existing, recommended, and/or circular dependencies, the dependency management system may notify users in advance when there are unforeseen delays potentially impacting an ability to meet deadlines (e.g., via virtual alerts, emails, and/or status summaries that include different visual indicators related to a current status of various dependencies, such as red to indicate dependencies that are subject to an alert or otherwise require attention, amber or yellow to indicate problematic dependencies that are being addressed, and/or green to indicate dependencies that are on track to be completed on time). Furthermore, in cases where a status associated with one or more dependency changes (e.g., timely attention from project professionals is needed to accomplish a work item by a planned completion date), the user interface may automatically change to reflect the status change associated with the dependency. Furthermore, in some implementations, the dependency management system may perform an impact analysis based on the existing and/or recommended dependencies based on baseline criteria in order to mitigate any unknown gaps in the project plan, which may improve a capability to ensure that work items are completed to resolve dependencies in a timely manner. Additionally, or alternatively, the dependency management system may generate one or more recommended action plans using the artificial intelligence model to mitigate delays in one or more work items that are associated with a dependency and automatically update risk logs or other project documentation to provide an audit trail for future reference. Furthermore, in some implementations, the user interface presented to the client device may enable interactions to drag and drop or otherwise manipulate work items, to associate work items with dependencies based on design artifacts, logs, knowledge nodes, and/or other information sources. In this way, the dependency management system may suggest critical dependencies to comprehensively cover an entire spectrum of a project from planning through execution and subsequent review.

In some implementations, as shown in FIG. 1C, and by reference number 160, the client device may provide one or more dependency filtering and/or query criteria to the dependency management system in order to customize the user interface for a particular use case. For example, in order to find all existing dependencies under a parent work item without including any recommended dependencies, a user may indicate one or more filtering criteria to specify an entity type, a release, a team, a sprint, and/or other suitable parameters to identify the work items that have existing dependencies with the parent work item. For any stories associated with the work item, relevant associations may be displayed in the user interface based on a dependency type (e.g., blocked by, depends on, or linked by), and the user may change an existing dependency type or add an existing work item as a new dependency. In another example, the user may provide filtering and/or query criteria to find all related work items and link the related work items to a parent work item, in which case the user can either accept or reject the recommended dependency. For example, as shown in FIG. 1D, and by reference number 165, the user interface may provide the user with an option to accept or reject a recommended dependency. Accordingly, as shown by reference number 170, the client device may provide one or more inputs to manage the dependencies, and the dependency management system may take appropriate action to process the input(s). For example, as shown by reference number 175, the project management data stored in the project management system(s) may be updated to formally store a recommended dependency when the one or more inputs accept a recommended dependency and/or modify an existing dependency. Additionally, or alternatively, as shown by reference number 180, the dependency management system may use rejected dependencies as feedback to further train the artificial intelligence model to self-correct and improve future recommendations. In still other examples, the user of the client device may interact with the dependency management system to identify all circular dependencies, which may occur when a parent node and a child node have a cross-dependent association, in which case a circular flag may be enabled and the user may validate the circular dependency or change the association to ensure that the circular dependency does not result in a deadlock that stalls or delays the progress of the project.

Accordingly, as described herein, the dependency management system may provide users with various capabilities to comprehensively identify dependencies associated with a project, accept or override recommended dependencies, perform an impact analysis, root cause analysis, and/or critical path analysis, and/or otherwise manage and plan for dependencies among work items associated with a project. Furthermore, in addition to improving project productivity by providing project professionals with insights into the dependencies in a project, inputs from the client device may be used as feedback to train the artificial intelligence or machine learning models to improve pattern recognition and generate more accurate predictions.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods described herein may be implemented. As shown in FIG. 2, environment 200 may include a dependency management system 201, which may include one or more elements of and/or may execute within a cloud computing system 202. The cloud computing system 202 may include one or more elements 203-212, as described in more detail below. As further shown in FIG. 2, environment 200 may include a project management system 220, a client device 230, and a network 240. Devices and/or elements of environment 200 may interconnect via wired connections and/or wireless connections.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 includes hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 includes a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the dependency management system 201 may include one or more elements 203-212 of the cloud computing system 202, may execute within the cloud computing system 202, and/or may be hosted within the cloud computing system 202, in some implementations, the dependency management system 201 may not be cloud-based (e.g., may be implemented outside of a cloud computing system) or may be partially cloud-based. For example, the dependency management system 201 may include one or more devices that are not part of the cloud computing system 202, such as device 300 of FIG. 3, which may include a standalone server or another type of computing device. The dependency management system 201 may perform one or more operations and/or processes described in more detail elsewhere herein.

The project management system 220 includes one or more devices capable of receiving, generating, storing, processing, providing, and/or routing information associated with dependencies among work items associated with a project, as described elsewhere herein. The project management system 220 may include a communication device and/or a computing device. For example, the project management system 220 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the project management system 220 may store project documentation or other information that includes text descriptions related to one or more requirements associated with a project and/or information related to a set of existing dependencies among work items associated with the project, as described elsewhere herein. The project management system 220 may communicate with one or more other devices of environment 200, as described elsewhere herein.

The client device 230 includes one or more devices capable of receiving, generating, storing, processing, and/or providing information associated with dependencies among work items associated with a project, as described elsewhere herein. The client device 230 may include a communication device and/or a computing device. For example, the client device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The client device 230 may communicate with one or more other devices of environment 200, as described elsewhere herein.

The network 240 includes one or more wired and/or wireless networks. For example, the network 240 may include a cellular network, a public land mobile network (PLMN), a local area network (LAN), a wide area network (WAN), a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the dependency management system 201, the project management system 220, and/or the client device 230 shown in FIG. 2. In some implementations, the dependency management system 201, the project management system 220, and/or the client device 230 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

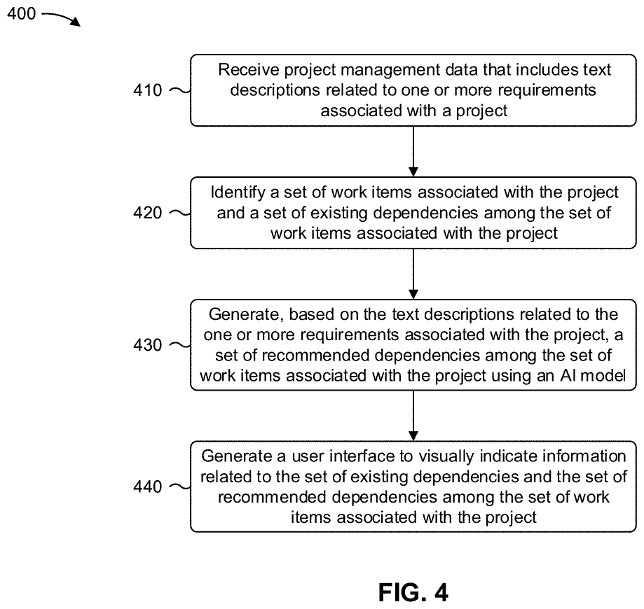

FIG. 4 is a flowchart of an example process 400 associated with intelligent dependency management. In some implementations, one or more process blocks of FIG. 4 are performed by a dependency management system (e.g., the dependency management system 201). In some implementations, one or more process blocks of FIG. 4 may be performed by another device or a group of devices separate from or including the dependency management system, such as a project management system (e.g., project management system 220) and/or a client device (e.g., client device 230). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving project management data that includes text descriptions related to one or more requirements associated with a project (block 410). For example, the dependency management system may receive project management data that includes text descriptions related to one or more requirements associated with a project, as described above.

As further shown in FIG. 4, process 400 may include identifying a set of work items associated with the project and a set of existing dependencies among the set of work items associated with the project (block 420). For example, the dependency management system may identify a set of work items associated with the project and a set of existing dependencies among the set of work items associated with the project, as described above. In some implementations, the set of work items and the set of existing dependencies associated with the set of work items are identified based on the project management data. In some implementations, each existing dependency of the set of existing dependencies defines a respective relationship between a first work item and a second work item.

As further shown in FIG. 4, process 400 may include generating, based on the text descriptions related to the one or more requirements associated with the project, a set of recommended dependencies among the set of work items associated with the project using an artificial intelligence model (block 430). For example, the dependency management system may generate, based on the text descriptions related to the one or more requirements associated with the project, a set of recommended dependencies among the set of work items associated with the project using an artificial intelligence model, as described above. In some implementations, the artificial intelligence model is trained to predict the set of recommended dependencies using historical data related to closed work items.

As further shown in FIG. 4, process 400 may include generating a user interface to visually indicate information related to the set of existing dependencies and the set of recommended dependencies among the set of work items associated with the project (block 440). For example, the dependency management system may generate a user interface to visually indicate information related to the set of existing dependencies and the set of recommended dependencies among the set of work items associated with the project, as described above. In some implementations, the user interface includes one or more elements to manage one or more of the set of existing dependencies or the set of recommended dependencies.

Process 400 may include additional implementations, such as any single implementation or any combination of implementations described below and/or in connection with one or more other processes described elsewhere herein.

In a first implementation, process 400 includes receiving one or more inputs related to interaction with the one or more elements included in the user interface, and processing the one or more inputs to manage one or more of the set of existing dependencies or the set of recommended dependencies.

In a second implementation, alone or in combination with the first implementation, processing the one or more inputs includes updating the project management data to include a recommended dependency, of the set of recommended dependencies, based on the one or more inputs accepting the recommended dependency.

In a third implementation, alone or in combination with one or more of the first and second implementations, processing the one or more inputs includes generating feedback to update the artificial intelligence model based on the one or more inputs rejecting a recommended dependency, of the set of recommended dependencies.

In a fourth implementation, alone or in combination with one or more of the first through third implementations, the artificial intelligence model includes a natural language processing model configured to generate the set of recommended dependencies based on similarity analytics that represent a closeness between two different text chunks included in the text descriptions related to the one or more requirements associated with the project.

In a fifth implementation, alone or in combination with one or more of the first through fourth implementations, the similarity analytics include a cosine similarity metric that measures the closeness between a first text chunk and a second text chunk according to a cosine of an angle between a first vector that represents the first text chunk and a second vector that represents the second text chunk.

In a sixth implementation, alone or in combination with one or more of the first through fifth implementations, process 400 includes receiving, via the user interface, one or more inputs to filter the information related to the set of existing dependencies and the set of recommended dependencies among the set of work items associated with the project, wherein the one or more inputs indicate one or more of a threshold to be used as a confidence score to generate the set of recommended dependencies or one or more criteria associated with a desired set of work items.

In a seventh implementation, alone or in combination with one or more of the first through sixth implementations, the user interface visually indicates whether a dependency, of the set of existing dependencies or the set of recommended dependencies, is an internal dependency between two work items within a scope of the project or an external dependency between a first work item that is within the scope of the project and a second work item that is outside the scope of the project.

In an eighth implementation, alone or in combination with one or more of the first through seventh implementations, the user interface visually indicates a type associated with each respective dependency included in the set of existing dependencies or the set of recommended dependencies, and the type associated with a particular dependency is a blocked by dependency, a depends on dependency, or a linked by dependency.

In a ninth implementation, alone or in combination with one or more of the first through eighth implementations, process 400 includes performing an impact analysis to identify one or more dependencies, of the set of existing dependencies or the set of recommended dependencies, that have a potential to delay the project or cause one or more deadlines associated with the project to be missed, and rendering, via the user interface, information to visually indicate a current status associated with the one or more dependencies that have the potential to delay the project or cause the one or more deadlines associated with the project to be missed.

In a tenth implementation, alone or in combination with one or more of the first through ninth implementations, process 400 includes determining, based on the set of existing dependencies and the set of recommended dependencies, a critical path that includes a sequence of work items to be completed before a deadline associated with the project, and rendering, via the user interface, information to visually indicate the critical path.

In an eleventh implementation, alone or in combination with one or more of the first through tenth implementations, process 400 includes generating one or more notifications based on a delay associated with one or more work items in the sequence of work items included in the critical path, determining a root cause associated with the delay based on the set of existing dependencies and the set of recommended dependencies, and rendering, via the user interface, information to visually indicate the root cause.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, project management data that includes text descriptions related to one or more requirements associated with a project;
identifying, by the device, a set of work items associated with the project and a set of existing dependencies among the set of work items associated with the project,
wherein the set of work items and the set of existing dependencies associated with the set of work items are identified based on the project management data, and
wherein each existing dependency of the set of existing dependencies defines a respective relationship between a first work item and a second work item;
generating, by the device and based on the text descriptions related to the one or more requirements associated with the project, a set of recommended dependencies among the set of work items associated with the project using an artificial intelligence model,
wherein the artificial intelligence model is trained to predict the set of recommended dependencies using historical data related to closed work items; and
generating, by the device, a user interface to visually indicate information related to the set of existing dependencies and the set of recommended dependencies among the set of work items associated with the project,
wherein the user interface includes one or more elements to manage one or more of the set of existing dependencies or the set of recommended dependencies.

2. The method of claim 1, further comprising:
receiving one or more inputs related to interaction with the one or more elements included in the user interface; and
processing the one or more inputs to manage one or more of the set of existing dependencies or the set of recommended dependencies.

3. The method of claim 2, wherein processing the one or more inputs includes updating the project management data to include a recommended dependency, of the set of recommended dependencies, based on the one or more inputs accepting the recommended dependency.

4. The method of claim 2, wherein processing the one or more inputs includes generating feedback to update the artificial intelligence model based on the one or more inputs rejecting a recommended dependency, of the set of recommended dependencies.

5. The method of claim 1, wherein the artificial intelligence model includes a natural language processing model configured to generate the set of recommended dependencies based on similarity analytics that represent a closeness between two different text chunks included in the text descriptions related to the one or more requirements associated with the project.

6. The method of claim 5, wherein the similarity analytics include a cosine similarity metric that measures the closeness between a first text chunk and a second text chunk according to a cosine of an angle between a first vector that represents the first text chunk and a second vector that represents the second text chunk.

7. The method of claim 1, further comprising:
receiving, via the user interface, one or more inputs to filter the information related to the set of existing dependencies and the set of recommended dependencies among the set of work items associated with the project,
wherein the one or more inputs indicate one or more of a threshold to be used as a confidence score to generate the set of recommended dependencies or one or more criteria associated with a desired set of work items.

8. The method of claim 1, wherein the user interface visually indicates whether a dependency, of the set of existing dependencies or the set of recommended dependencies, is an internal dependency between two work items within a scope of the project or an external dependency between a first work item that is within the scope of the project and a second work item that is outside the scope of the project.

9. The method of claim 1, wherein:
the user interface visually indicates a type associated with each respective dependency included in the set of existing dependencies or the set of recommended dependencies, and
the type associated with a particular dependency is a blocked by dependency, a depends on dependency, or a linked by dependency.

10. The method of claim 1, further comprising:
performing an impact analysis to identify one or more dependencies, of the set of existing dependencies or the set of recommended dependencies, that have a potential to delay the project or cause one or more deadlines associated with the project to be missed; and
rendering, via the user interface, information to visually indicate a current status associated with the one or more dependencies that have the potential to delay the project or cause the one or more deadlines associated with the project to be missed.

11. The method of claim 1, further comprising:
determining, based on the set of existing dependencies and the set of recommended dependencies, a critical path that includes a sequence of work items to be completed before a deadline associated with the project; and
rendering, via the user interface, information to visually indicate the critical path.

12. The method of claim 11, further comprising:
generating one or more notifications based on a delay associated with one or more work items in the sequence of work items included in the critical path;
determining a root cause associated with the delay based on the set of existing dependencies and the set of recommended dependencies; and
rendering, via the user interface, information to visually indicate the root cause.

13. A device, comprising:
one or more memories; and
one or more processors, coupled to the one or more memories, configured to:
receive project management data that includes text descriptions related to one or more requirements associated with a project;
identify a set of work items associated with the project and a set of existing dependencies among the set of work items associated with the project,
wherein the set of work items and the set of existing dependencies associated with the set of work items are identified based on the project management data, and
wherein each existing dependency of the set of existing dependencies defines a respective relationship between a first work item and a second work item;
generate, based on the text descriptions related to the one or more requirements associated with the project, a set of recommended dependencies among the set of work items associated with the project using an artificial intelligence model;
generate a user interface to visually indicate information related to the set of existing dependencies and the set of recommended dependencies among the set of work items associated with the project;
receive one or more inputs related to interaction with one or more elements included in the user interface; and
process the one or more inputs to manage one or more of the set of existing dependencies or the set of recommended dependencies, wherein the one or more processors, to process the one or more inputs, are configured to:
update the project management data to include a recommended dependency, of the set of recommended dependencies, based on the one or more inputs accepting the recommended dependency; and
generate feedback to update the artificial intelligence model based on the one or more inputs rejecting a recommended dependency, of the set of recommended dependencies.

14. The device of claim 13, wherein the artificial intelligence model includes a natural language processing model configured to generate the set of recommended dependencies based on a cosine similarity metric that represent a closeness between two different text chunks included in the text descriptions related to the one or more requirements associated with the project.

15. The device of claim 13, wherein the user interface visually indicates whether a dependency, of the set of existing dependencies or the set of recommended dependencies, is an internal dependency between two work items within a scope of the project or an external dependency between a first work item that is within the scope of the project and a second work item that is outside the scope of the project.

16. The device of claim 13, wherein:
the user interface visually indicates a type associated with each respective dependency included in the set of existing dependencies or the set of recommended dependencies, and
the type associated with a particular dependency is a blocked by dependency, a depends on dependency, or a linked by dependency.

17. A non-transitory computer-readable medium storing a set of instructions, the set of instructions comprising:
one or more instructions that, when executed by one or more processors of a device, cause the device to:
receive project management data that includes text descriptions related to one or more requirements associated with a project;
identify a set of work items associated with the project and a set of existing dependencies among the set of work items associated with the project,
wherein the set of work items and the set of existing dependencies associated with the set of work items are identified based on the project management data, and
wherein each existing dependency of the set of existing dependencies defines a respective relationship between a first work item and a second work item;
generate, based on the text descriptions related to the one or more requirements associated with the project, a set of recommended dependencies among the set of work items associated with the project using an artificial intelligence model;
perform an impact analysis to identify one or more dependencies, of the set of existing dependencies or the set of recommended dependencies, that have a potential to delay the project or cause one or more deadlines associated with the project to be missed;
determine, based on the set of existing dependencies and the set of recommended dependencies, a critical path that includes a sequence of work items to be completed before a deadline associated with the project; and
generate a user interface to visually indicate information related to one or more of the set of existing dependencies, the set of recommended dependencies among the set of work items associated with the project, a current status associated with the one or more dependencies that have the potential to delay the project or cause the one or more deadlines associated with the project to be missed, or the critical path.

18. The non-transitory computer-readable medium of claim 17, wherein the one or more instructions further cause the device to:
generate one or more notifications based on a delay associated with one or more work items in the sequence of work items included in the critical path;
determine a root cause associated with the delay based on the set of existing dependencies and the set of recommended dependencies; and
render, via the user interface, information to visually indicate the root cause.

19. The non-transitory computer-readable medium of claim 17, wherein the artificial intelligence model includes a natural language processing model configured to generate the set of recommended dependencies based on similarity analytics.

20. The non-transitory computer-readable medium of claim 17, wherein:
the user interface visually indicates whether a dependency, of the set of existing dependencies or the set of recommended dependencies, is an internal dependency between two work items within a scope of the project or an external dependency involving one or more work items that are outside the scope of the project, and
the user interface visually indicates a type associated with each respective dependency included in the set of existing dependencies or the set of recommended dependencies.
